(19) United States
(12) Patent Application Publication
(10) Pub. No.: US 2026/0099518 A1
(43) Pub. Date: Apr. 9, 2026

(54) Model Based API Mocking

(71) Applicant: Scaled Cognition, Inc., Amesbury, MA (US)

(72) Inventors: Mathew Gardner, Irvine, CA (US); Adam Pauls, Berkeley, CA (US); Jordan DeLoach, New York, NY (US)

(73) Assignee: Scaled Cognition, Inc., Amesbury, MA (US)

(21) Appl. No.: 18/908,285

(22) Filed: Oct. 7, 2024

(51) Int. Cl. G06F 16/3329; H04L 51/02

(52) U.S. Cl. CPC G06F 16/33295; H04L 51/02

(57) ABSTRACT

The present technology, roughly described, provides for mocking an application program interface (API) using a large language model (LLM). The present system generates a prompt with API signature information and API desired behavior information. The prompt can include instructions, library functions, examples, executed programs, and a current function invocation, as well as other content. The prompt can be generated, and submitted to an LLM to mock an API and generate a response. The response can be audited and the LLM can be fine tuned to provide improved performance in subsequent calls.

### BACKGROUND

When building an automated agent that can interact with the real world, the assistants are run through simulations to evaluate effectiveness and develop a reliable product. Since some assistants interact with remote services, it can be very difficult to use the remote services in simulations. A standard software engineering practice for allowing simulation with APIs is to provide a simulated API that acts as the real API for the purposes of simulation. However, these simulated API applications are static, require significant manual labor to create, and often do not do a good job of simulating a dynamic remote service. What is needed is an improved system for performing simulations for an automated agent.

### SUMMARY

The present technology, roughly described, provides for mocking an application program interface (API) using a large language model (LLM). The present system generates a prompt with API signature information and API desired behavior information. The prompt can include instructions, library functions, examples, executed programs, and a current function invocation, as well as other content. The prompt can be generated, and submitted to an LLM to mock an API and generate a response. The response can be audited and the LLM can be fine tuned to provide improved performance in subsequent calls.

In some instances, the present technology performs a method for mocking an application program interface. The method begins with generating, by a first application on a first server, an application program interface (API) signature for the API to be mocked. The method then generates, by the first application, a desired behavior for the API to be mocked. A prompt is generated that includes the API signature, the API desired behavior, and world state data, wherein the desired behavior includes instructions to a machine learning model, and the world state data includes one or more values related to an operation that initiated creation of the prompt. The one or more values are maintained on a second server remote from the first server. The method continues with submitting the prompt to a large language model (LLM). Next, a response is received from the LLM based on the prompt, the LLM response mocking a response that would be provided by the API based on a call to the API using data contained within the prompt.

In some instances, the present technology includes a non-transitory computer readable storage medium having embodied thereon a program, the program being executable by a processor to perform a method for mocking an application program interface. The method begins with generating, by a first application on a first server, an application program interface (API) signature for the API to be mocked. The method then generates, by the first application, a desired behavior for the API to be mocked. A prompt is generated that includes the API signature, the API desired behavior, and world state data, wherein the desired behavior includes instructions to a machine learning model, and the world state data includes one or more values related to an operation that initiated creation of the prompt. The one or more values are maintained on a second server remote from the first server. The method continues with submitting the prompt to a large language model (LLM). Next, a response is received from the LLM based on the prompt, the LLM response mocking a response that would be provided by the API based on a call to the API using data contained within the prompt.

In some instances, the present technology includes a system having one or more servers, each including memory and a processor. One or more modules are stored in the memory and executed by one or more of the processors to generate, by a first application on a first server, an application program interface (API) signature for the API to be mocked, generate, by the first application, a desired behavior for the API to be mocked, generate a prompt that includes the API signature, the API desired behavior, and world state data, the desired behavior including instructions to a machine learning model, the world state data including one or more values related to an operation that initiated creation of the prompt, the one or more values maintained on a second server remote from the first server, submit the prompt to a large language model LLM, and receive a response from the LLM based on the prompt, the LLM response mocking a response that would be provided by the API based on a call to the API using data contained within the prompt.

### BRIEF DESCRIPTION OF FIGURES

FIG. 1 is a block diagram of a system for mocking an API.

FIG. 2 illustrates a block diagram of an API simulator application.

FIG. 3 illustrates a block diagram of a dataflow for a machine learning model.

FIG. 4 illustrates a method for mocking an API.

FIG. 5 illustrates a method for preparing and sending a request to mock an API.

FIG. 6 illustrates a method for preparing a prompt to submit to a large language.

FIG. 7 illustrates a method for specifying API desired behavior.

FIG. 8 illustrates a method for preparing constraints on an API output.

FIG. 9 illustrates a pseudo-prompt.

FIG. 10 illustrates a computing environment for use with the present technology.

### DETAILED DESCRIPTION

The present technology, roughly described, provides for mocking an application program interface (API) using a large language model (LLM). The present system generates a prompt with API signature information and API desired behavior information. The prompt can include instructions, library functions, examples, executed programs, and a current function invocation, as well as other content. The prompt can be generated, and submitted to an LLM to mock an API and generate a response. The response can be audited and the LLM can be fine tuned to provide improved performance in subsequent calls.

The desired behavior can be represented in several ways. For example, desired behavior can be represented with instructions. Instructions can include general instructions to be followed each session or context specific instructions which should be followed in particular situations.

Examples can also be used to specify desired behavior. Examples can include API example input/output pairs that indicate an API's output in response to a particular API input. Another tool for specifying desired behavior includes manual override data, such as for example in lookup table. A lookup table with input/output pairs can be used to override an API output when an input similar to one in the lookup table is provided to the mocked API.

Constraints can also be used to specify desired behavior. Constraints on the output of an LLM can be used to ensure that the output is in an interpretable form. Examples of constraints include requiring LLM mocked API output to be in a serialization format, outputs to be structured to confirm to a specified schema, or restricting output values based on context.

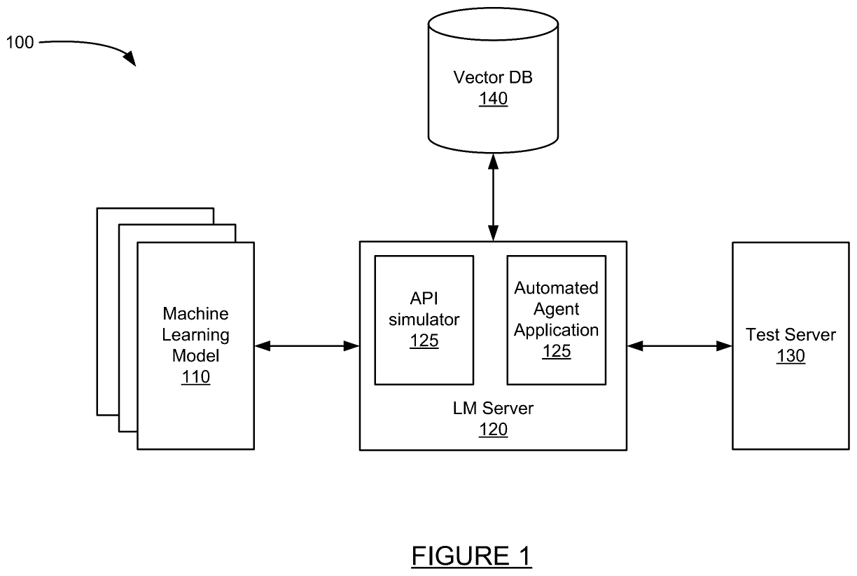

FIG. 1 is a block diagram of a system for mocking an API. The system of FIG. 1 includes machine learning model 110, language model server 120, simulation server 130 and vector database 140. Machine learning model 110 may include one or more large language models that can receive a prompt, process the prompt, and return an output.. In some instances, machine learning model (LM) 110 may be implemented on one or more servers implementing language model server 120. In some instances, machine learning model 110 may be implemented by a large language model (LLM), on one or more servers external to LM server 120. Machine learning model 110 may be implemented as one or more models, on one or more machines, and in one or more environments

Each of the one or more LLMs may mock an API. The call to the mocked API may be made as part of generating a response in a simulated conversation between an automated agent application and a customer. In some instances, one or more of the LLMs may mock an API for an operation unrelated to a simulated conversation between an automated agent and a simulated customer.

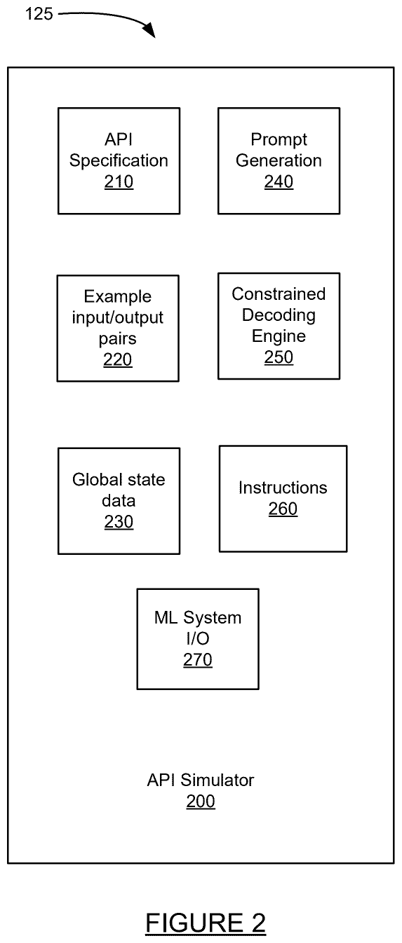

Language model server 120 may be implemented as one or more servers that implement an automated agent application 125 and an API simulator application 127. The automated agent application may engage in a real or simulated conversation with a real customer or simulated customer, respectively. When engaged in a simulated conversation, the automated agent application may make calls to an API through API simulator 125. The API calls may be mocked by the API simulator and one or more machine learning models 110 implemented as LLMs. More details for API simulator 125 are discussed with respect to the block diagram of FIG. 2.

Simulation server 130 may implement a customer engaged in a simulated conversation with an automated agent application 125. In some instances, simulation server 130 may submit queries to automated agent application 125 through an interaction. A simulation server generated query may initiate agent application 125 to prepare and submit a call to an API.

Vector database 140 may be implemented as a data store that stores vector data. In some instances, vector database 140 may be implemented as more than one data store, internal to system 100 or exterior to system 100. In some instances, a vector database can serve as an LLMs' long-term memory and expand an LLMs' knowledge base. Vector database 140 can store private data or domain-specific information outside the LLM as embeddings. Vector database 140 may include data such as instructions, examples, constraint data, and other data used by LM application 125 and machine learning models 110.

In some instances, the present system may include one or more additional data stores, in place of or in addition to vector database 140, at which the system stores searchable data such as instructions, private data, domain-specific data, and other data.

Each of models 110, servers 120-130 and vector database 140 may communicate over one or more networks. The networks may include one or more the Internet, an intranet, a local area network, a wide area network, a wireless network, Wi-Fi network, cellular network, or any other network over which data may be communicated.

In some instances, one or more of machines associated with devices and/or machines 110-170 may be implemented in one or more cloud-based service providers, such as for example AWS by Amazon Inc, AZURE by Microsoft, GCP by Google, Inc., Kubernetes, or some other cloud based service provider.

FIG. 2 illustrates a block diagram of an API simulator application. The API simulator 200 of FIG. 2 provides more detail for API simulator 125 of FIG. 1. API simulator 200 includes API specification 210, example input/output pairs 220, global state data 230, prompt generation module 240, constrained decoding engine 250, instructions 260, and machine learning system input/output 270.

API specification 210 may include a specification, signature, and/or other data associated with an API to be mocked by one or more LLMs. The API specification data may be stored locally on language model server 120 or is accessible from one or more remote machines.

Example input/output pairs can include one or more API input/output examples that can be used to indicate a desired API behavior. The input of an I/O pair may include a call provided to a real API which the LLM is mocking. The output of the I/O pair includes the API response generated after receiving the input. I/O pairs may be included in a prompt generated by API simulator and submitted to an LLM to mock the API.

Global state data 230 may include data related to systems outside of the language model server 120. Examples of goals state data include reservation numbers, hotel availability, and other data maintained by systems outside of LM sever 120. The global state data can be included in the prompt and utilized by the LLM mocking an API to track values related to an operation or inquiry initiated by a customer, for example during a simulated interaction with an automated agent application.

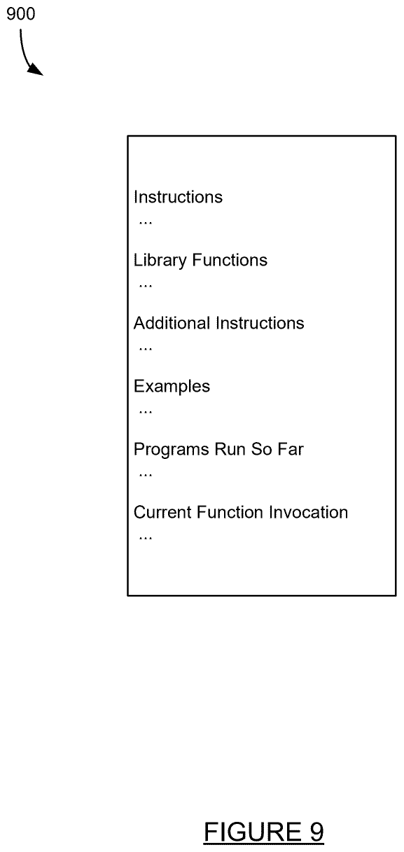

Prompt generation module 240 may generate a prompt to be sent to an LLM, enabling the LLM to mock an API. The prompt may include several parts, including instructions, examples, global state data, and other data. A pseudo prompt is discussed with respect to FIG. 9.

Constrained decoding engine 250 may constrain the possible outputs generated by a machine learning model in response to a given prompt. Constraints may be placed on the format of an answer, the schema of an API output, and other aspects of the machine learning model output.

Instructions may include general instructions and context specific instructions. General instructions may include instructions that can be performed regardless of any particular state. Context specific instructions are instructions that will not always be followed, but should be followed when a particular state is present.

Machine learning system input/output communicates with one or more machine learning models 110. The ML I/O 270 may submit a generated prompt to a machine learning model and receive output from a machine learning model. Machine learning system I/O may also provide machine learning model output to one or more of the modules within API simulator 200 or other applications within server 120.

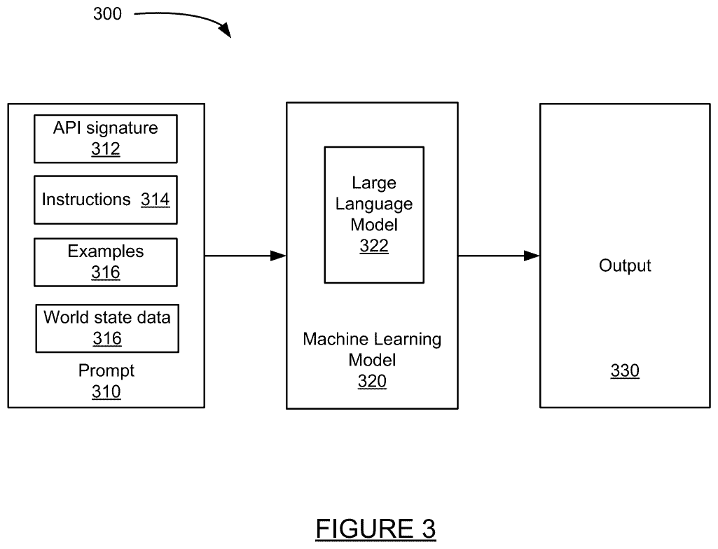

FIG. 3 illustrates a block diagram of a dataflow for a machine learning model. Machine learning model system of FIG. 3 includes a prompt 310, machine learning model 320, and output 330. Machine learning model 320 can be implemented by an LLM 322.

Prompt 310 may includes several parts, including but not limited to an API signature, instructions, examples, and world state data. Prompt 310 may include each of portions 312-316, each of which can be included one or more times within a prompt. For example, a prompt requesting an LLM to mock an API can include a first set of instructions and a first part of the prompt and additional instructions in another part of the prompt.

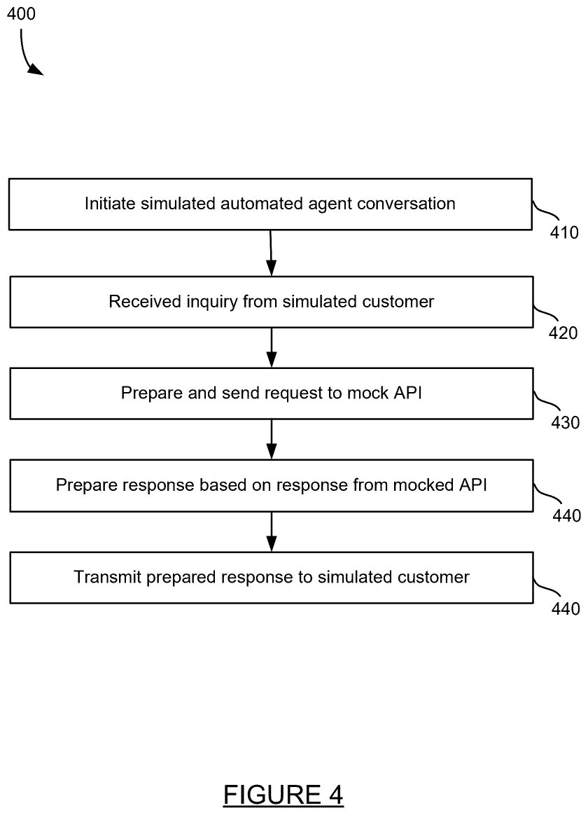

Machine learning model 420 of FIG. 4 provides more detail for machine learning model 110 of FIG. 1. The ML model 420 may receive one or more inputs and provide an output.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data.

In some instances, the present technology may use an LLM such as a BERT LLM, Falcon 30B on GitHub, Galactica by Meta, GPT-3 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model provide a probability that a particular token is the next token in a sequence, the output will include a probability. The output can be provided to other parts of the present system.

FIG. 4 illustrates a method for mocking an API. Though FIG. 4 discusses an example of mocking an API during a simulated conversation between an automated agent and a simulated customer, and API can be mocked in other scenarios as well. The presently described technology for mocking an API is not intended to be limited to responding to an inquiry from a simulated customer within an interaction between an automated agent and a simulated customer.

The method of FIG. 4 begins with initiating a simulated automated agent conversation. The simulated an automated agent conversation can be initiated by automated agent application 125 or simulation server 130 in the system of FIG. 1. An inquiry can be received from the simulated customer implemented by server 130 at step 420.

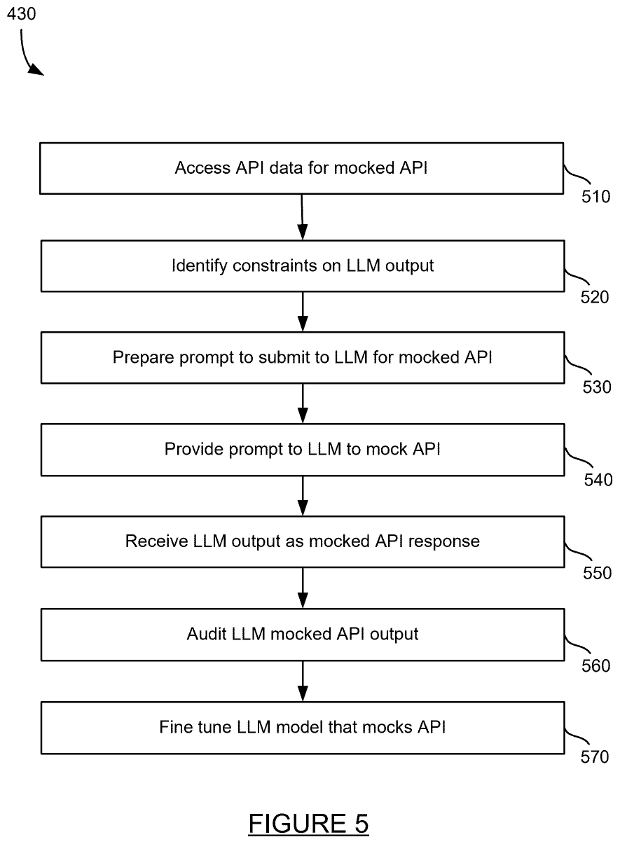

The inquiry can be received by agent application 125 which may then make a call to an API to process the inquiry. The request to the API is handled by a mocked API provided by API simulator 125 and machine learning models 110. Preparing and sending a request to a mocked API at step 430 is discussed in more detail with respect to the method of FIG. 5.

Once the mocked API provides a response, a response in the simulated conversation, based on the mocked API response, is prepared at step 440. The prepared response may then be transmitted to the simulated customer at step 440.

FIG. 5 illustrates a method for preparing and sending a request to mock an API. The method of FIG. 5 provides more detail for step 430 of the method of FIG. 4. API data is accessed for the mocked API at step 510. The API data may include an API specification, which includes but is not limited to an address, variables, and other data for the API.

Constraints on an LLM output can be identified at step 520. Constraints on the LLM output may specify an output format, a structured output may be constrained to conform to a specified schema, and constraining output values based on context. In some instances, the constraints may be implemented by a constrained decoding engine. More details for a constrained decoding engine are disclosed with respect to U.S. patent application Ser. No. 18/751,047, filed on Jun. 21, 2024, the disclosure of which is incorporated herein by reference.

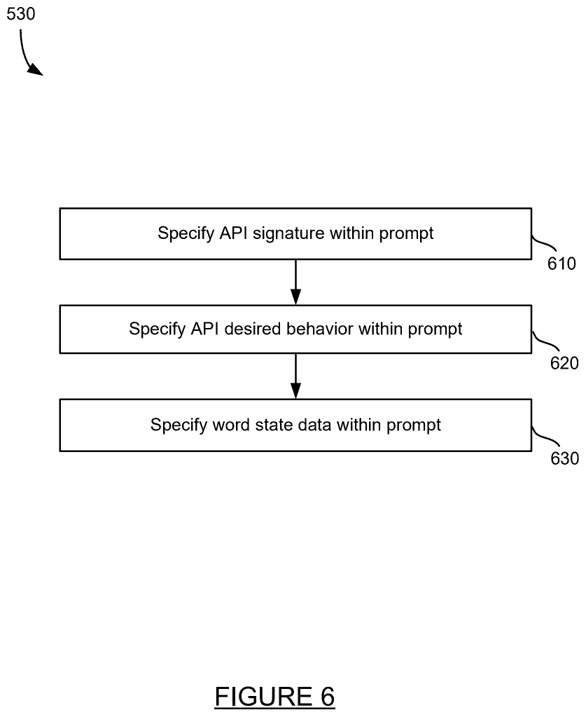

A prompt to submit to a large language model for mocking an API is prepared at step 530. The prompt may include API signature data and API desired behavior data. The prompt may be generated by API simulator 125 and transmitted to one or more LLMs 110. More details for preparing a prompt to submit to an LLM for mocking an API are discussed with respect to the method of FIG. 6.

The generated prompt is provided to the LLM to mock an API call at step 540. The LLM receives the prompt, processes the prompt, and generates an output. The LLM output is received as a mocked API response at step 550.

The output provided by the LLM can be audited at step 560. In some instances, different example prompts and responses can be provided to one or more LLMs to determine the accuracy of the mocked API output. The LLM model which was audited can be fine-tuned at step 570. The fine-tuning can be performed based on the results of the audit which can indicates the accuracy the mocked API. Fine tuning the LLM can include modifying the prompt to transmit to the LLM which mocks the API.

FIG. 6 illustrates a method for preparing a prompt to submit to a LLM. The method of FIG. 6 provides more detail for step 530 of the method of FIG. 5. Generating a prompt may begin with specifying an API signature within the prompt at step 610. The API signature may be generated from, for example, an API specification for the API to be mocked. The API specification information may include variables, addresses, and other aspects of an API call.

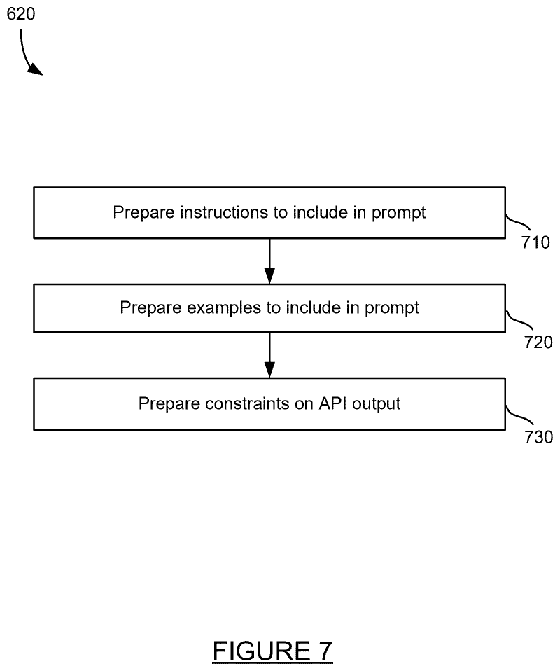

API desired behavior is specified within the prompt at step 620. Specifying API desired behavior can be achieved and several ways. In some instances, specifying API desired behavior can be achieved with one or more of the instructions, examples, and API constraints. More detail for specifying API desired behavior is discussed with respect to the method of FIG. 7.

World state data is specified within a prompt at step 630. The world state data may indicate values that have been established related to a conversation, interaction, or other operation and established by systems outside of language model server 120. World state data may include information such as past API calls, representations of state subsystems witty the agent at racks, such as for example a reservation number provided by a remote reservation system, the current operations in the results, and other world state data accessible within a conversation between the automated agent in the simulation server.

FIG. 7 illustrates a method for specifying API desired behavior. The method of FIG. 7 provides more detail for step 620 of the method of FIG. 6. First, instructions are prepared to include in the prompt at step 710. The instructions may include general instructions and context specific instructions. The general instructions may be applied for each invocation or call to the mocked API. Context specific instructions may only relate to a specific library function or specific instance, and may provide a specific response, such as for example an error.

Examples are prepared to include in the prompt at step 720. The examples may include input output pairs, instructions for handling previous in similar cases, and other examples. The examples can include general examples as well as context specific examples. In some instances, the examples may include an example API input and an example API output as an API I/O pair, and can be accompanied by guidelines for determining whether a current mocked API call is similar. These examples may be used within a prompt for “few shot prompting,”, to guide a response to the current task.

Constraints on an API output can be prepared at step 730. Constraints on API output may predict an API output in a selected format, where the API structured output should be required to conform to a specific schema, or the API output values to be restricted based on context. A constraint on the API to predict an output in a selected format may constrain the output to a serialization or JSON format. An API constrained to a structured output to conform to a specified schema may be constrained to a JSON schema.

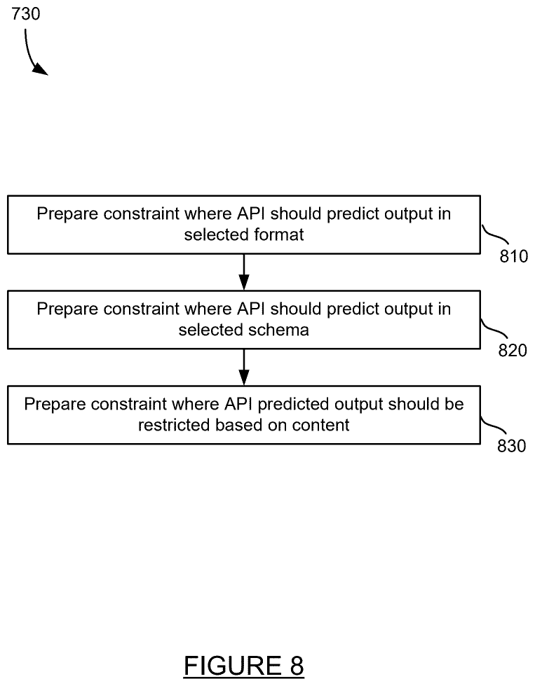

FIG. 8 illustrates a method for preparing constraints on an API output. The method of FIG. 8 provides more detail for step 730 the method of FIG. 7. Preparing constraints can include an output in a selected format at step 810.

A constraint can be prepared where the API predicts an output in a selected schema at step 820. A constraint where an API structured output is required to conform to a specified schema may include a constraint to conform to a JSON schema. A constraint for an API predicted output restricted based on content is prepared at step 830. An example of a constraint with the APA output values restricted based on content includes constraining photos to active URLs—requiring a response portion to be something real, or constrain at label data.

FIG. 9 illustrates a pseudo-prompt. The pseudo-prompt models represent different parts of a prompt submitted t to a machine learning model in order to mock an API. The pseudo-prompt 900 of FIG. 9 may include portions such as instructions, library functions, additional instructions, examples, programs run so far, and current function invocation. The parts of the prompt and other content may be in natural language or in a structured format.

The instructions portion of a prompt may indicate to the LLM what is being mocked, the content of the prompt, the job of the large language model, details about the return value, and other instructions. An example of initial instructions to include in a prompt for an LLM used to mock an API is as follows:
a. “You are mocking a python API library. I will show you the list of functions that are available in this library with their documentation, a sequence of programs that have been run so far with their results, and an invocation of a function in that library. Your job is to produce the correct return value for that function, keeping in mind the prior history of what has been run so far. Your return value should be consistent with the programs that have been run so far—you should act as an interactive python interpreter, keeping track of whatever internal API state might be necessary to produce coherent sequential results. Sometimes the correct return value will be impossible to predict, because there is missing information. In those cases, you can feel free to make up plausible values, as long as they are consistent with the program history.
b. Sometimes the functions in the library say they should return errors for some inputs. When you think the right thing to do is to raise an error, you should construct an appropriate Exception object (like a ValueError) and return that as your output. We will handle the raise call separately.”

The library functions portion may include a set of available functions and types. In some instances, each function in a library of functions may be provided with comments, for example where the schema was derived from, attributes, and other function information.

Additional instructions may indicate specific instructions for an LLM regarding how it should act in particular scenarios. For example, additional instructions may indicate context specific instructions, what to do in a particular scenario, and other instructions. An example of additional instructions is as follows:
a. “Here are some specific instructions to follow when producing program results. Not all of them will be applicable to all function invocations that you encounter, but when it is applicable, follow the instruction.
   1. There is no availability on October 4, don't return any offers that include that date.
   2. You are talking to a user named John Doe with email address john@johndoe.com. He has platinum elite bonvoy status and a plausible number of stays and points for that status.”

Examples included in a prompt may include past prompts used to mock in API, the return values, and may be at additional instructions. Examples may be provided as input/output pairs for an API within the prompt.

The prompt may also include programs run thus far within an interaction session between the automated agent and the simulated customer. An indication for the programs may indicate that they should impact the results of the current program, include details for the programs, and the data that the programs returned.

A prompt used to mock API can include a current function invocation. The current function invocation can specify the API to mock as well as other behavioral instructions. An example of a current function invocation within a prompt for mocking an API is as follows:
a. “>>> make_reservation(user_id=1, hotel_id=BRYVRBRB, check_in=datetime.date(2024, 9, 30), check_out=datetime.date(2024,10, 02)
b. Output the return value for this function invocation, without using any backticks. When you are constructing objects, if the constructor has default values for some arguments, you can omit values for those arguments if you just want to use the default value. If there are required arguments that you don't have any information for, like names, email addresses, dates, etc., you should use creative values for those arguments. If the output type is a string, remember to surround it in quotes.”

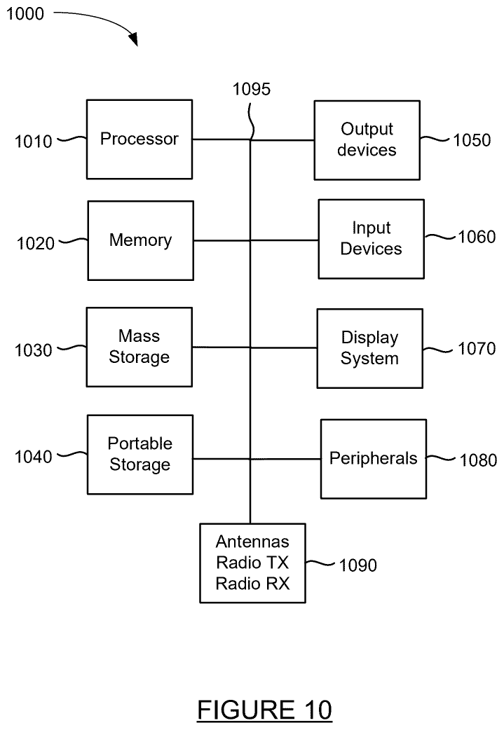

FIG. 10 illustrates a computing environment for use with the present technology. System 1000 of FIG. 10 may be implemented in the contexts of the likes of machines that implement machine learning models 110, LM server 120, interaction simulation test server 130, and vector DB 140. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1095. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive, an optical disk drive, a flash drive, or other device, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, USB drive, memory card or stick, or other portable or removable memory, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other device.

The system of 1000 may also include, in some implementations, antennas, radio transmitters and radio receivers 1090. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, iOS, ANDROID, as well as languages including Python, PHP, Java, Ruby,. NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for mocking an application program interface, comprising:
generating, by a first application on a first server, an application program interface (API) signature for the API to be mocked;
generating, by the first application, a desired behavior for the API to be mocked; and
generating a prompt that includes the API signature, the API desired behavior, and world state data, the desired behavior including instructions to a machine learning model, the world state data including zero or more values related to an operation that initiated creation of the prompt, the zero or more values maintained on a second server remote from the first server;
submitting the prompt to a large language model LLM; and
receiving a response from the LLM based on the prompt, the LLM response mocking a response that would be provided by the API based on a call to the API using data contained within the prompt.

2. The method of claim 1, wherein the API desired behavior includes examples of API inputs and outputs.

3. The method of claim 1, wherein the API desired behavior includes constraints on API output.

4. The method of claim 3, wherein the constraints include a selected format of the mocked API output.

5. The method of claim 3, wherein the constraints include a specified format for a structured mocked API output.

6. The method of claim 1, wherein the LLM is fine-tuned based on an audit of the LLM response.

7. The method of claim 1, wherein the mocked API call is related to an interaction between an automated agent and a simulated customer.

8. A non-transitory computer readable storage medium having embodied thereon a program, the program being executable by a processor to mocking an application program interface, the method comprising:
generating, by a first application on a first server, an application program interface (API) signature for the API to be mocked;
generating, by the first application, a desired behavior for the API to be mocked; and
generating a prompt that includes the API signature, the API desired behavior, and world state data, the desired behavior including instructions to a machine learning model, the world state data including zero or more values related to an operation that initiated creation of the prompt, the zero or more values maintained on a second server remote from the first server;
submitting the prompt to a large language model LLM; and
receiving a response from the LLM based on the prompt, the LLM response mocking a response that would be provided by the API based on a call to the API using data contained within the prompt.

9. The non-transitory computer readable storage medium of claim of claim 8, wherein the API desired behavior includes examples of API inputs and outputs.

10. The non-transitory computer readable storage medium of claim of claim 8, wherein the API desired behavior includes constraints on API output.

11. The non-transitory computer readable storage medium of claim of claim 10, wherein the constraints include a selected format of the mocked API output.

12. The non-transitory computer readable storage medium of claim of claim 10, wherein the constraints include a specified format for a structured mocked API output.

13. The non-transitory computer readable storage medium of claim of claim 8, wherein the LLM is fine-tuned based on an audit of the LLM response.

14. The non-transitory computer readable storage medium of claim of claim 8, wherein the mocked API call is related to an interaction between an automated agent and a simulated customer.

15. A system for automatically rendering a prompt, comprising:
one or more servers, wherein each server includes a memory and a processor; and
one or more modules stored in the memory and executed by at least one of the one or more processors to generate, by a first application on a first server, an application program interface (API) signature for the API to be mocked, generate, by the first application, a desired behavior for the API to be mocked, generate a prompt that includes the API signature, the API desired behavior, and world state data, the desired behavior including instructions to a machine learning model, the world state data including one or more values related to an operation that initiated creation of the prompt, the one or more values maintained on a second server remote from the first server, submit the prompt to a large language model LLM, and receive a response from the LLM based on the prompt, the LLM response mocking a response that would be provided by the API based on a call to the API using data contained within the prompt.

16. The system of claim 15, wherein the API desired behavior includes examples of API inputs and outputs.

17. The system of claim 15, wherein the API desired behavior includes constraints on API output.

18. The system of claim 15, wherein the constraints include a selected format of the mocked API output.

19. The system of claim 15, wherein the constraints include a specified format for a structured mocked API output.

20. The system of claim 15, wherein the LLM is fine-tuned based on an audit of the LLM response.
